(19) United States
(12) Patent Application Publication
(10) Pub. No.: US 2007/0183618 A1
(43) Pub. Date: Aug. 9, 2007

(54) Moving object equipped with ultra-directional speaker

(76) Inventors: Masamitsu Ishii, Tokyo (JP); Shinichi Sakai, Tokyo (JP); Hiroshi Okuno, Kyoto (JP); Kazuhiro Nakadai, Saitama (JP); Hiroshi Tsujino, Saitama (JP)

Correspondence Address: BIRCH STEWART KOLASCH & BIRCH, PO BOX 747, FALLS CHURCH, VA, 22040-0747, US

(21) Appl. No.: 10/588,801

(22) PCT Filed: Feb. 10, 2005
(86) PCT No.: PCT/JP05/02044

§ 371 Date: Aug. 9, 2006

(30) Foreign Application Priority Data
Feb. 10, 2004 (JP) 2004-033979

(51) Int. Cl. H04R 1/02; H04R 3/00

(52) U.S. Cl. 381/387; 381/96

(57) ABSTRACT

An ultra-directional speaker having a modulator 33 for modulating an ultrasonic carrier signal with an input electric signal from an audible sound signal source, and an emitter 44 for emitting an output of the modulator 33 is mounted in a moving object 1 having a target tracking system for sensing a target in a surrounding space in real time using the above-mentioned emitter 44. The moving object equipped with ultra-directional speaker can therefore transmit a voice only to a specific target through parametric action caused by the nonlinearity of finite amplitude of ultrasonic wave.

### FIELD OF THE INVENTION

The present invention relates to a moving-object-mounted sound apparatus equipped with an ultra-directional speaker for directionally emitting out an audible sound, the sound apparatus being mounted in a moving object having a person-tracking function.

### BACKGROUND OF THE INVENTION

Conventionally, there have been provided nondirectional speakers which can emit sounds in all directions, and high-directivity ultra-directional speakers. Nondirectional speakers have been widely used. An ultra-directional speaker generates a sound having frequencies within the range of human hearing by using distortion components which are generated when a strong ultrasonic wave propagates through the air, and concentrates the generated sound to a front side thereof and makes it propagate, thereby offering sounds having high directivity. Such a parametric speaker is disclosed by, for example, patent reference 1.

A robot equipped with audiovisual system is disclosed by, for example, patent reference 2. This moving object equipped with audiovisual system can carry out a real-time process of performing visual and sound tracking on a target. This system is further-adapted to unify several pieces of sensor information about a visual sensor, an audio sensor, a motor sensor, etc., and, even if any one of the plural pieces of sensor information is lost, continue the tracking by complementing the lost piece of sensor information.

Patent reference 1: JP, 2001-346288, A

Patent reference 2: JP, 2002-264058, A

A problem with related art moving objects is that since a speaker mounted therein is a nondirectional one although they can track a target, many surrounding unspecified things can hear a voice provided to the target, and therefore they cannot provide the voice only to a specific person or a limited area.

Although parametric speakers provide high directivity as ultra-directional speakers and can limit an audible area, they cannot recognize a specific listener so as to limitedly transmit any voice to the listener.

The present invention is made in order to solve the above-mentioned problems, and it is therefore an object to provide a moving object that can transmit a specific voice to a specific listener by being equipped with an ultra-directional speaker therein.

### DISCLOSURE OF THE INVENTION

A moving object equipped with ultra-directional speaker in accordance with the present invention has a nondirectional speaker and an ultra-directional speaker, and is also equipped with a visual module, an auditory module, a motor control module, and an integration unit that integrates them with one another, so that the moving object can simultaneously transmit sounds to a specific target and an unspecified target, respectively.

Therefore, the present invention offers an advantage of being able to provide a specific voice to a specific listener by outputting the voice from the moving object by using the ultra-directional speaker.

The moving object can also transmit a voice according to the circumstances by using a combination of the ultra-directional speaker and nondirectional speaker. That is, the transmission of information by switching between these speakers, such as transmission of private information by using the ultra-directional speaker, and transmission of general information by using the nondirectional speaker, can widen the scope of the information transmission method of the present invention. Furthermore, the moving object can transmit different pieces of information to two or more persons by different sounds, respectively, by using two or more ultra-directional speakers, without mixture of the different sounds (i.e., crosstalk between them).

### BRIEF DESCRIPTION OF THE FIGURES

FIG. 1 is a front view of a moving object according to this embodiment 1;

FIG. 2 is a side view of the moving object according to this embodiment 1;

FIG. 3 is a diagram showing regions where sounds emitted from an ultra-directional speaker and a nondirectional speaker in accordance with embodiment 1 of the present invention are transmitted, respectively;

FIG. 4 is a block diagram of the ultra-directional speaker according to embodiment 1 of the present invention;

FIG. 5 is a diagram showing the whole of a system according to embodiment 1;

FIG. 6 is a diagram showing details of an auditory module according to this embodiment 1;

FIG. 7 is a diagram showing details of a visual module according to this embodiment 1;

FIG. 8 is a diagram showing details of a motor control module according to this embodiment 1;

FIG. 9 is a diagram showing details of a dialog module according to this embodiment 1;

FIG. 10 is a diagram showing details of an integration unit according to this embodiment 1;

FIG. 11 is a diagram showing an area in which a camera according to this embodiment 1 detects a target;

FIG. 12 is a diagram explaining a target tracking system according to embodiment 1 of the present invention;

FIG. 13 is a diagram showing a variant of embodiment 1 of the present invention;

FIG. 13 is a diagram showing another variant of embodiment 1 of the present invention; and

FIG. 15 is a diagram showing a case where the moving object according to embodiment 1 of the present invention measures the distance to the target.

### PREFERRED EMBODIMENTS OF THE INVENTION

Hereafter, in order to explain this invention in greater detail, the preferred embodiments of the present invention will be described with reference to the accompanying drawings. Embodiment 1.

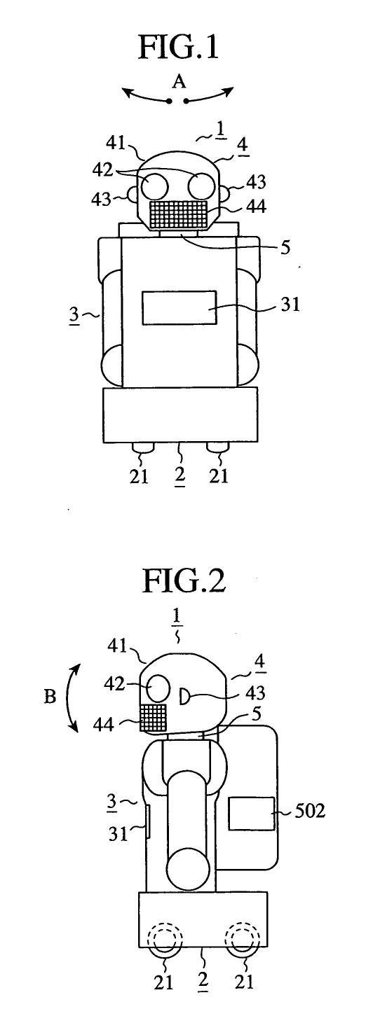

FIG. 1 is a front view of a moving object according to this embodiment 1, and FIG. 2 is a side view of the moving object according to this embodiment 1. As shown in FIG. 1, the humanoid moving object 1 has a leg 2, a body 3 which is supported on the leg 2, and a head 4 which is movably supported on the body 3.

The leg 2 is provided with either two or more wheels 21 at a lower portion thereof, and can be moved when controlled by a motor which will be mentioned below. The leg 2 can be provided with two or more leg moving means, as the above-mentioned moving mechanism, instead of the wheels. The body 3 is supported on and fixed to the leg 2. The head 4 is connected to the body 3 by way of a connecting member 5, and this connecting member 5 is supported on the body 3 so as to pivot around a vertical axis of the body, as indicated by arrows A. The head 4 is also supported on the connecting member 5 so as to shake in upward and downward directions, as indicated by an arrow B.

While the whole of the head 4 is covered by a soundproofing outer jacket 41, the head 4 is equipped with cameras 42 on a front side thereof, as a visual device which takes charge of the robot's vision, and a pair of microphones 43 on both lateral sides thereof, as a hearing device which takes charge of the robot's hearing.

The microphones 43 are attached to the two lateral sides of the head 4, respectively, so as to have directivity in a direction that is in front of the moving object.

A nondirectional speaker 31 is disposed in a front surface of the body 3, and an emitter 44 that is an emitting unit of an ultra-directional speaker which exhibits high directivity on the basis of the principle of a parametric speaker array is disposed in the head 4.

A parametric speaker uses an ultrasonic wave which human beings cannot hear, and adopts a principle (nonlinearity) of generating a sound having frequencies within the range of human hearing by using distortion components which are generated when a strong ultrasonic wave propagates through the air. The parametric speaker exhibits “ultra-directional” characteristics in which the generated audible sound is concentrated to a narrow area in the shape of a beam and in the direction of the emission of the sound, although it has a low degree of conversion efficiency for generating the audible sound. Since a nondirectional speaker forms a sound field in a wide area including the back thereof, as if light from a naked light bulb spreads out in all directions, the nondirectional speaker cannot control the area in which the sound field is formed. On the other hand, a speaker for use in a parametric speaker can limit an area where human beings can hear to a small area as if they are spotlighted.

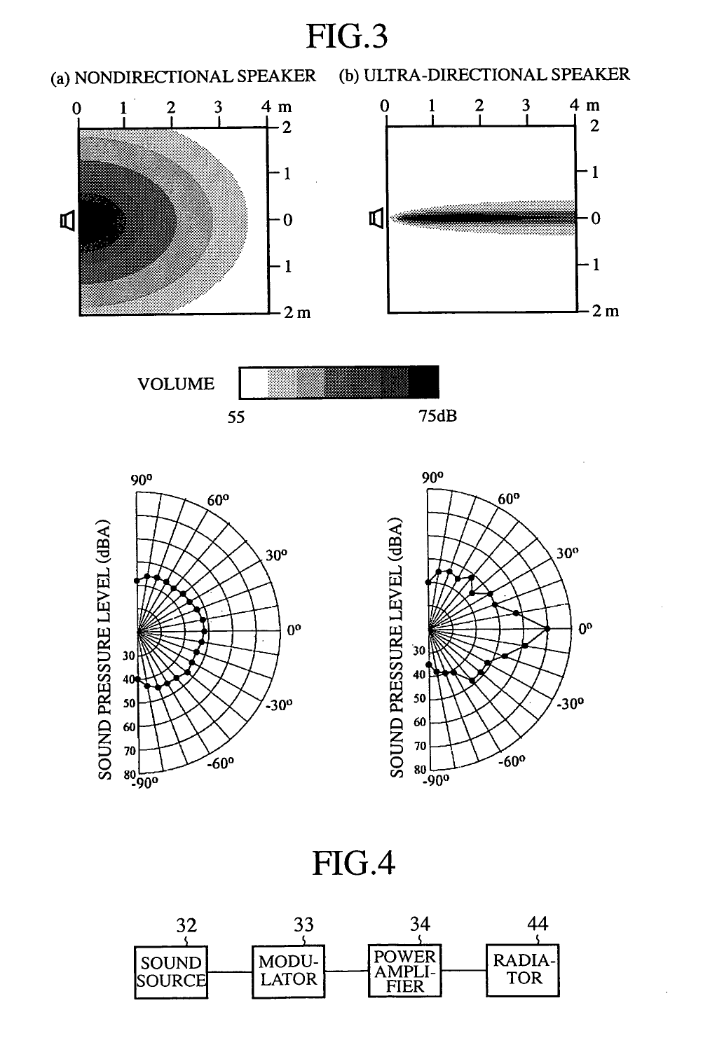

Propagation of sounds emitted from the nondirectional speaker and ultra-directional speaker is schematically shown in FIG. 3. Figures shown on an upper side of FIG. 3 are diagrams of the contours of the sound pressure levels of the sounds which are respectively emitted from the ultra-directional speaker and nondirectional speaker and propagate through the air, and figures shown on a lower side of FIG. 3 are diagrams showing measurement values of the sound pressure levels. It is apparent that the sound emitted from the nondirectional speaker spreads as shown in FIG. 3(a) so that it can be heard in surroundings. On the other hand, it is apparent that the sound emitted from the ultra-directional speaker propagates so as to be concentrated to an area that is placed in front of the ultra-directional speaker. This is because the ultra-directional speaker uses the parametric speaker principle of generating a sound having frequencies within the range of human hearing by using distortion components which are generated when a strong ultrasonic wave propagates through the air. As a result, the example shown in FIG. 3(b) can offer a sound having high directivity.

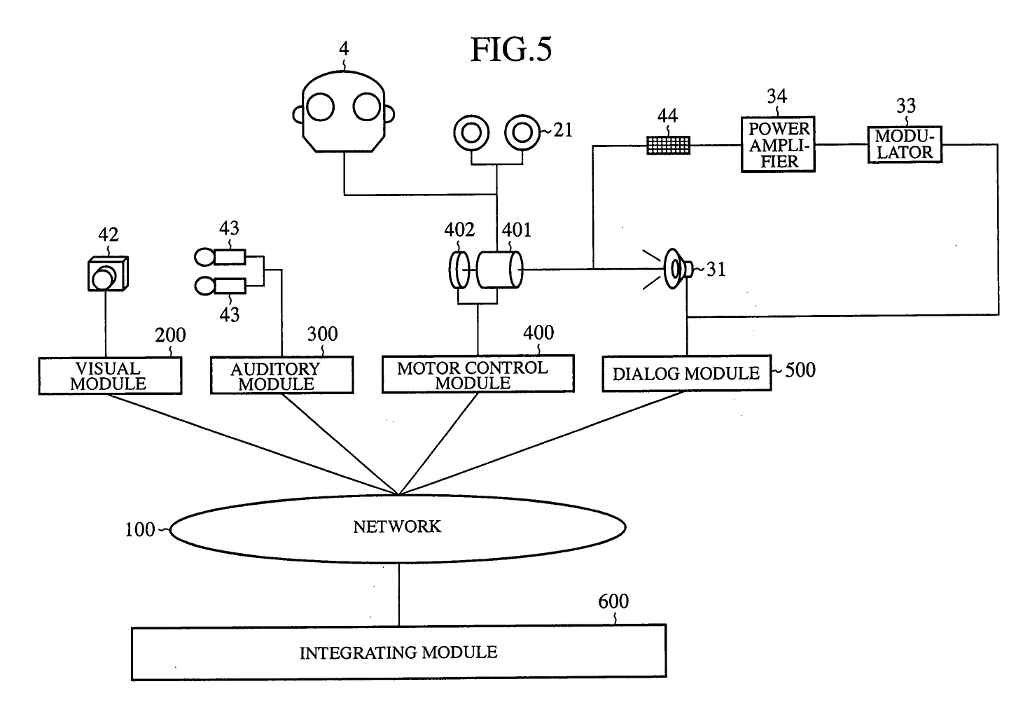

As shown in FIG. 4, the ultra-directional speaker system of this embodiment is provided with a sound source 32 which is an audible sound signal source, a modulator 33 for modulating an ultrasonic carrier signal with an input electric signal which is based on a signal from the sound source 32, a power amplifier 34 for amplifying a signal from the modulator 33, and the emitter 44 for converts the signal acquired with the modulation into a sound wave.

In order to drive the parametric speaker, the modulator needs to extract an audio signal from the input electric signal and emit an ultrasonic wave according to the amplitude of the audio signal. Therefore, an envelopment modulator for digital processing is suitable for this modulator since the envelopment modulator can faithfully extract a modulating process with the signal and can easily perform fine adjustment.

FIG. 5 shows the electrical structure of a control system for controlling the moving object. In FIG. 5, the control system is provided with a network 100, an auditory module 300, a visual module 200, a motor control module 400, a dialog module 500, and an integration unit 600. Hereafter, each of the auditory module 300, visual module 200, motor control module 400, dialog module 500, and integration unit 600 will be explained.

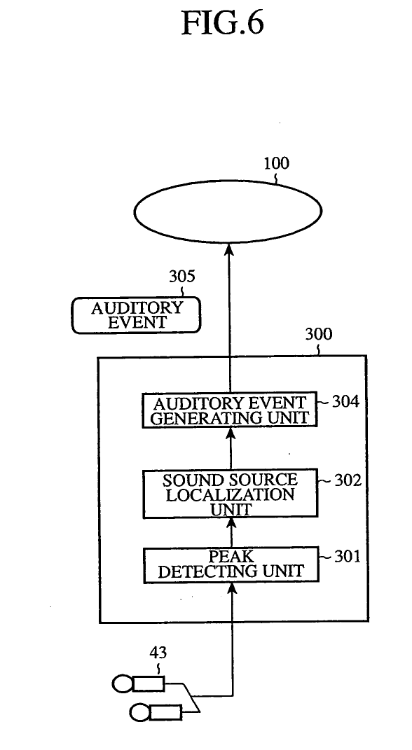

FIG. 6 shows a detail view of the auditory module. The auditory module 300 is provided with the microphones 43, a peak detecting unit 301 and a sound source localization unit 302, and an auditory event generating unit 304.

The auditory module 300 extracts a series of peaks for each of right hand side and left hand side channels from acoustical signals from the microphones 43, by using the peak detecting unit 301, and pairs peaks extracted for the right hand side and left hand side channels with each other, the peaks having the same amplitude or similar amplitudes. The extraction of the peaks is carried out by using a band-pass filter which allows only data which satisfy, for example, conditions that their powers are equal to or larger than a threshold and are maximum values, and their frequencies range from 90 Hz to 3 kHz to pass therethrough. The magnitude of surrounding background noise is measured, and a sensitivity parameter, e.g., 10 dB is further added to the measured magnitude of surrounding background noise to define the threshold.

The auditory module 300 then finds out a more accurate peak for the right hand side and left hand side channels so as to extract a sound having a harmonic structure by using a fact that each of the peaks has a harmonic structure. The peak detecting unit 301 performs frequency analysis on the sounds inputted via the microphones 43, detects peaks from obtained spectra, and extracts peaks having a harmonic structure from the acquired peaks. The sound source localization unit 302 selects an acoustical signal having the same frequency from each of the right hand side and left hand side channels for each extracted peak, and acquires a binaural phase difference so as to localize the direction of a sound source in a robot coordinates system. The auditory event generating unit 304 generates an auditory event 305 which consists of the direction of the sound source which is localized by the sound source localization unit 302, and a time of the localization, and transmits the auditory event to the network 100. When two or more harmonic structures are extracted by the peak detecting unit 301, two or more auditory events 305 are outputted to the network.

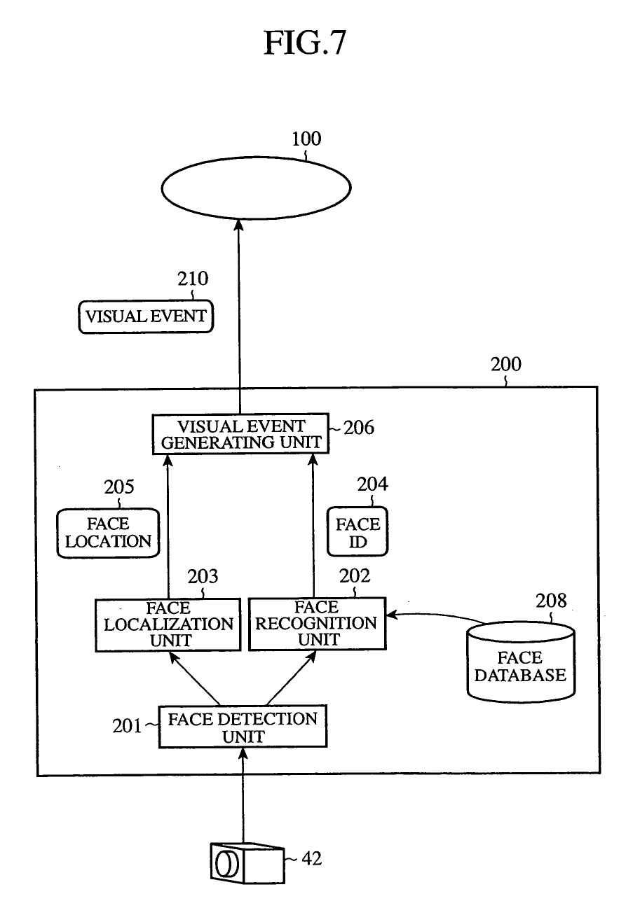

FIG. 7 shows a detail view of the visual module. The visual module 200 is provided with the cameras 42, a face detection unit 201, a face recognition unit 202, a face localization unit 203, a visual event generating unit 206, and a face database 208.

The visual module 200 extracts each speaker's face image region on the basis of an image picked-up by the cameras with, for example, a skin-color extraction method by using the face detection unit 201, searches through face data which are beforehand registered into the face database 208 and, when detecting face data that matches with the face image region, specifies a corresponding face ID 204 and identifies the face of each speaker by using the face recognition unit 202, and determines the face location 205 of the face in the robot coordinates system on the basis of the position and size of the extracted face image region within the picked-up image by using the face localization unit 203. The visual event generating unit 206 then generates a visual event 210 which consists of the face ID 204, face location 205, and a time of the determination of these data, and outputs the visual event to the network. When two or more faces are found from the picked-up image, two or more visual events 210 are outputted to the network. The face recognition unit 202 performs database retrieval on each extracted face image region using template matching which is known image processing disclosed by patent reference 1. The face database 208 has a one-to-one correspondence between individuals' face images and their names, different IDs being assigned to the names.

When the face detection unit 201 finds two or more faces from the image signal, the visual module 200 performs the above-mentioned processing, i.e., recognition and localization on each of the two or more faces. In this case, since the size, orientation, and lightness of each of the two or more faces detected by the face detection unit 201 often change, the face detection unit 201 performs face region detection on each of the two or more faces and detects the two or more faces correctly with a combination of skin-color extraction and pattern matching based on a correlation operation.

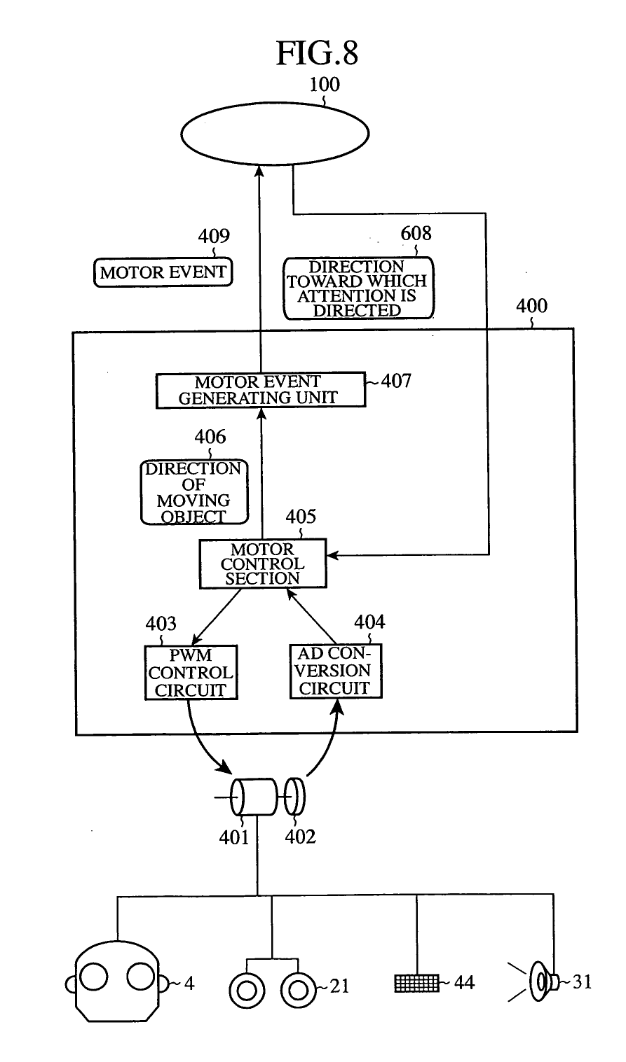

FIG. 8 shows a detail view of the motor control module. The motor control module 400 is provided with a motor 401 and a potentiometer 402, a PWM control circuit 403, an AD conversion circuit 404 and a motor control unit 405, a motor event generating unit 407, and the wheels 21, robot head 4, emitter 44 and nondirectional speaker 31 which are driven by the motor 401.

The motor control module 400 performs planning of the operation of the moving object 1 on the basis of a direction 608 toward which the moving object 1 is to direct attention, which is acquired from the integration unit 600 which will be mentioned below, and, if there is a necessity to drive the motor 401, drives and controls the motor 401 by way of the PWM control circuit 403 by using the motor control unit 405.

For example, the planning of the operation of the moving object is to move the wheels so that the moving object 1 moves toward the target on the basis of the information about the direction toward which the moving object is to direct attention. When the moving object 1 is so constructed as to direct the head 4 toward the target without moving itself by rotating the head 4 horizontally, the moving object 1 can control a motor for rotating the head 4 horizontally so as to direct the head 4 toward the target. In addition, in a case where the emitter 44 cannot be oriented toward the head of the target, such as a case where the target is sitting down, a case where there is a small or large difference in height between the moving object and the target, or a case where the target is staying at a place with a level difference, the moving object 1 can control a motor for shaking the head 4 of the moving object 1 in upward and downward directions so as to control the orientation in which the emitter 44 is oriented.

The motor control module 400 drives and controls the motor 401 by way of the PWM control circuit 403, detects the rotational direction of the motor by using the potentiometer 402, extracts the orientation 406 of the moving object by way of the AD conversion circuit 404 by using the motor control unit 405, generates a motor event 409 which consists of the motor rotational direction information and a time of the detection of the motor rotational direction by using the motor event generating unit 407, and outputs the motor event to the network 100.

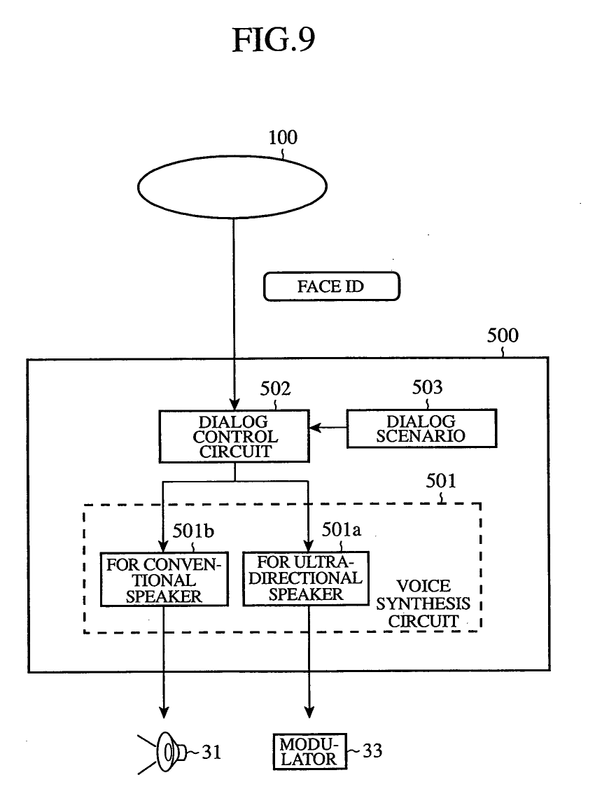

FIG. 9 shows a detail view of the dialog module. The dialog module 500 is provided with the speaker, a voice synthesis circuit 501, a dialog control circuit 502, and a dialog scenario 503.

The dialog module 500 controls the dialog control circuit 502 on the basis of the face ID 204 delivered thereto from the integration unit 600, which will be mentioned below, and the dialog scenario 503, drives the nondirectional speaker 31 by using the voice synthesis circuit 501, and outputs a predetermined voice. The voice synthesis circuit 501 functions as a sound source for the ultra-directional speaker using high-directivity parametric characteristics, and outputs the predetermined voice to a target speaker. What the moving object tells whom at which timing is described in the above-mentioned dialog scenario 503. The dialog control circuit 502 incorporates the name included in the face ID 204 into the dialog scenario 503, voice-synthesizes the contents described in the dialog scenario 503 by using the voice synthesis circuit 501 according to the timing described in the dialog scenario 503, and drives the ultra-directional speaker or nondirectional speaker 31. Switching between the nondirectional speaker 31 and the emitter 44 and proper use of either of them are controlled by the dialog control circuit 502.

The emitter 44 is so constructed as to transmit a sound to a specific listener or a specific area in synchronization with the target tracking means, and the nondirectional speaker 31 is so constructed as to transmit share information to many unspecified things. The system can thus track the target using the auditory module, motor control module, integration unit, and network which are included in the above-mentioned structural components (target tracking means). The system can improve the tracking accuracy by additionally using the visual module. The system can also control the orientation of the emitter 44 by using the integration unit, motor control module, dialog module, and network (emitter orientation control means)

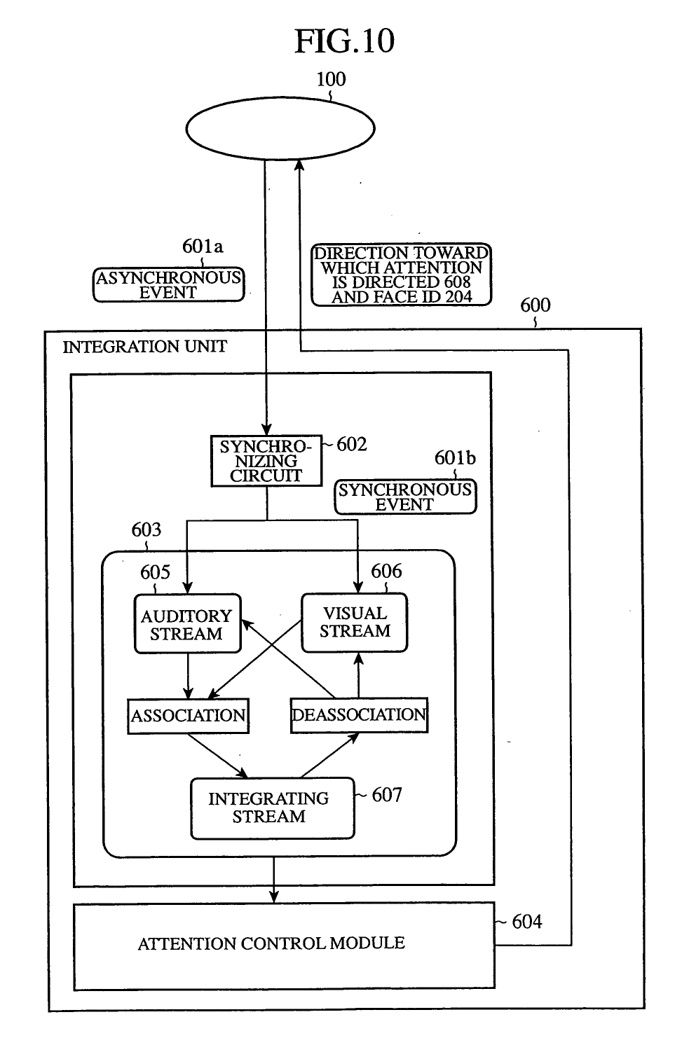

FIG. 10 shows a detail view of the integration unit. The integration unit 600 integrates the auditory module 300, visual module 200, and motor control module 400, which are mentioned above, with one another, and generates an input to be applied to the dialog module 500. Concretely, the integration unit 600 is provided with a synchronizing circuit 602 which synchronizes an asynchronous event 601a, i.e., the auditory event 305, the visual event 210 and motor event 409 from the auditory module 300, visual module 200, and motor control module 400, so as to generate synchronous events 601b, a stream generating unit 603 which associates these synchronous events 601b with one another, and generates an auditory stream 605, a visual stream 606, and an integrated stream 607, and an attention control module 604.

The synchronizing circuit 602 synchronizes the auditory event 305 from the auditory module 300, the visual event 210 from the visual module 200, and the motor event 409 from the motor control module 400, and generates a synchronous auditory event, a synchronous visual event, and a synchronous motor event. At this time, the synchronous auditory event and synchronous visual event are converted into values in an absolute coordinate system using the synchronous motor event.

The events which are synchronized is then converted into a series of streams which are connected in series with respect to time, the series of streams including an auditory stream which is formed form the auditory event and a visual stream which is formed from the visual event. On this occasion, when two or more sounds and two or more faces are found simultaneously, two or more auditory streams and two or more visual streams are formed. In addition, a visual stream and an auditory stream which are closely associated with each other are combined (association) into a higher-order stream called an integrated stream.

The attention control module determines a direction 608 toward which the moving object is to direct attention with reference to sound source direction information which the formed auditory stream, vision, and integrated streams have. The attention control module refers to these streams in order of the integrated streams, auditory streams, and visual streams. When there is an integrated stream, the attention control module defines the direction of the sound source associated with the integrated stream as the direction 608 toward which the moving object is to direct attention. When there is no integrated stream, the attention control module defines the auditory stream as the direction 608 toward which the moving object is to direct attention. When there are no integrated stream and no auditory stream, the attention control module defines the direction of the sound source associated with the visual stream as the direction 608 toward which the moving object is to direct attention.

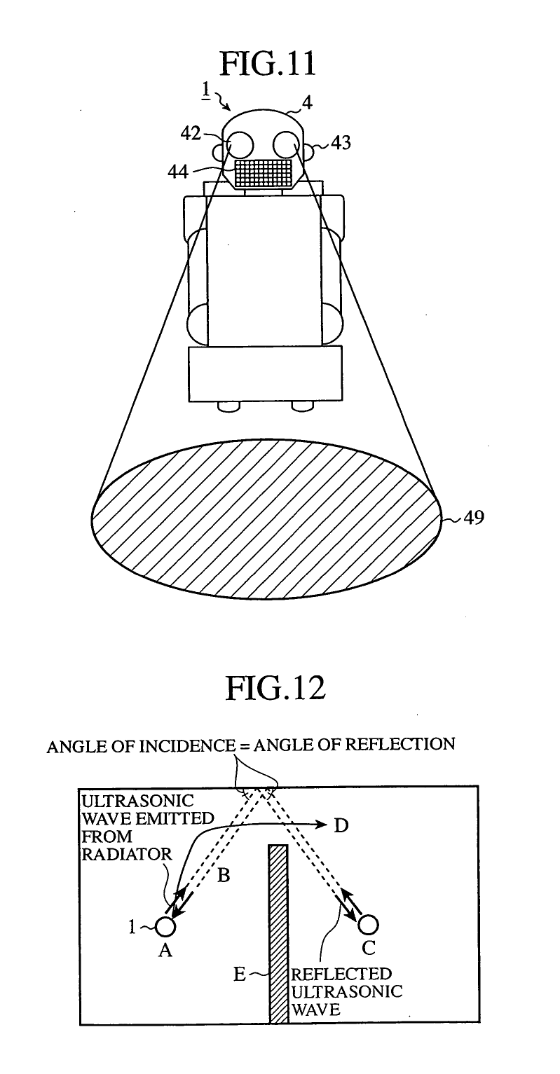

Hereafter, an example of the use of the above-mentioned moving object will be explained. Information about a room in which the moving object is to be used is inputted into the moving object in advance, and information about how the moving object moves according to a sound which it receives from which direction and at which location of the room is preset to the moving object. The target tracking means of the moving object 1 is further preset so that the moving object determines that a human being is hiding and then takes an action (e.g., move) to look for the face of the human being when not finding out any human being in the direction of the sound source because of obstacles, such as walls of the room. The cameras 42 of the moving object 1 are disposed in the front surface of the head 4, and a region 49 which they can pick up is limited to a part of an area in front of the cameras 42, as shown in FIG. 11. For example, as shown in FIG. 12, when an obstacle E exists in the room, the moving object may be unable to detect any visitor who has entered the room. Therefore, the moving object 1 is preset so as to control a motor for driving the wheels by using the wheel drive module 800 and to move toward a location D if the moving object 1 cannot find out a visitor C because the moving object is located at A and the sound source is placed in a direction of B. The moving object can thus eliminate blind spots in the angle of view which are caused by the obstacle E and so on by performing such an active operation. As an alternative, the moving object 1 can transmit a voice to the visitor C by using reflection of the ultrasonic wave even if the moving object 1 does not move toward the direction D.

The target tracking means which are preset in this way can unify the auditory information and visual information and can sense its surrounding environments robustly. As an alternative, the target tracking means can unify the audiovisual processing and operation, can sense its surrounding environments more robustly, and can provide an improvement in scene analysis.

When a person enters the room, the moving object 1 which is on standby in the room controls a motor for driving the wheels 21 and a motor for driving the head so that the cameras of the moving object are oriented toward a direction from which a voice generated by the person reaches.

When the visitor's information is known beforehand, the moving object registers the visitor's face into the face database 208 beforehand and enables itself to identify the face ID 204 by using the visual module. The dialog module 500 identifies the name of the visitor on the basis of the face ID obtained by the integration unit, and says to the visitor “Welcome, Mr. (or Ms.) Tanaka” with voice synthesis by using either the nondirectional speaker 31 or the emitter 44 which is the emitting unit of the ultra-directional speaker.

Next, a case where there are two or more visitors will be explained. In this case, the dialog module 500 controls the dialog controlling circuit so as to make a synthesized voice “Welcome, everybody” by using the nondirectional speaker 31 such that all the visitor scan hear the voice. The moving object identifies each of the visitors by using the visual module 200, as in the case where there is only one visitor.

The moving object can transmit a voice to a specific one of the two or more visitors by using the emitter 44 which is an ultra-directional speaker. Therefore, since only a visitor to whom the moving object has asked the visitor's name answers his or her name because all other visitors cannot hear the question, the moving object can surely register the visitor into the face database 208 without making any mistakes.

When there is only one visitor, the moving object can transmit information only to the visitor uneventfully using any one of a normal speaker, the nondirectional speaker 31 and emitter 44 which is the emitting unit of the ultra-directional speaker. In contrast, when there are two or more visitors, the moving object can transmit information only to a specific visitor by using the ultra-directional speaker. By using the target tracking means provided with a target tracking system for recognizing and tracking a target, and the emitter orientation control means provided with a target tracking system for controlling the emitter so that the emitter is oriented toward the target which is being tracked by the target tracking means, the moving object can transmit a voice only to the specific target.

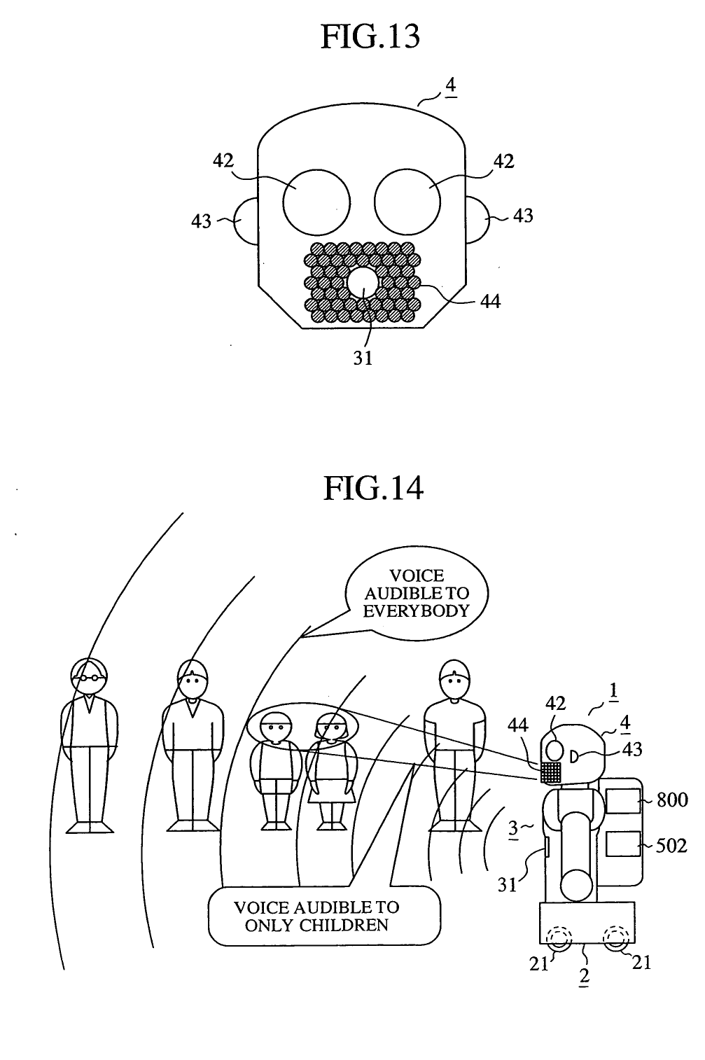

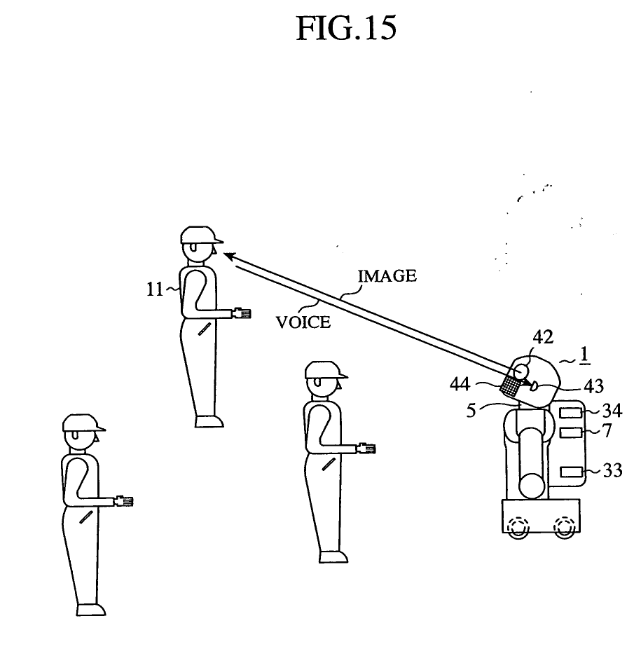

In the above-mentioned embodiment, although the example in which the nondirectional speaker 31 is disposed in the body 3 is explained, the nondirectional speaker 31 can be in the vicinity of the emitter 44 which is the emitting unit of the ultra-directional speaker disposed in the front surface of the head 4, as shown in FIG. 13.

In the above-mentioned embodiment, the example in which the emitter 44 is disposed in the head 4 of the moving object is explained. When the moving object can be so constructed as to change the orientation of the emitter 44 which is the emitting unit of the ultra-directional speaker and that of the cameras 42, instead of rotating and shaking the head 4 using motors, the positions where the emitter 44 and cameras 42 are disposed is not limited to the head 4, and therefore the emitter 44 and cameras 42 can be disposed at any position of the moving object

Although the example in which one emitter 44 is disposed is explained, two or more emitters 44 can be disposed and the orientation of each of the two or more emitters 44 can be controlled independently. According to this structure, the moving object can provide different voices only to two or more specific persons, respectively.

In the above-mentioned embodiment, although the example using the face database 208 is explained, instead of managing visitors individually, the moving object can identify each visitor's height by using a combination of existing sensors so as to discriminate between children and adults on the basis of height information, can transmit a voice only to the children from the emitter 44, and can use only the nondirectional speaker 31 for ordinary listeners. As shown in FIG. 14, when there are three adult visitors and two child visitors, the moving object can recognize only the children from their heights and transmit a specific voice only to the children.

The moving object can also perform image processing on the image picked-up by the cameras 42, and can transmit a certain voice to a specific group of persons, such as those who are wearing glasses, from the emitter 44. In this case, when there are foreigners in the group, the moving object can transmit the same voice in a foreign language, such as English or French, which matches with each foreigner's native language, to each foreigner.

### INDUSTRIAL APPLICABILITY

As mentioned above, the moving object equipped with ultra-directional speaker in accordance with the present invention has a nondirectional speaker and an ultra-directional speaker, and is also equipped with a visual module, an auditory module, a motor control module, and an integration unit that integrates them with one another, so that the moving object can simultaneously transmit sounds to a specific target and an unspecified target, respectively. The present invention is therefore suitable for application to robots equipped with audiovisual system, etc.

1. A moving object equipped with ultra-directional speaker, characterized in that said moving object has a nondirectional speaker and an ultra-directional speaker, and is also equipped with a visual module, an auditory module, a motor control module, and an integration unit that integrates them with one another, so that said moving object can simultaneously transmit sounds to a specific target and an unspecified target, respectively.

2. The moving object equipped with ultra-directional speaker according to claim 1, characterized in that said moving object transmits a sound only to the specific target by using a target tracking means that recognizes and tracks a target, and an emitter orientation control means that controls an emitter so that the emitter is oriented toward the target tracked by said target tracking means.

3. The moving object equipped with ultra-directional speaker according to claim 2, characterized in that said moving object transmits different voices to the specific target and unspecified target, respectively, by transmitting the voice to the unspecified target by using the nondirectional speaker, and transmitting the voice to the specific target by using the ultra-directional speaker.
